(19) United States
(12) Patent Application Publication
(10) Pub. No.: US 2025/0331674 A1
(43) Pub. Date: Oct. 30, 2025

(54) DEVICE FOR FROTHING MILK AND COFFEE MACHINE INCLUDING SUCH DEVICE

(71) Applicant: DE' LONGHI APPLIANCES S.r.l., Treviso (IT)

(72) Inventors: Antonio PANCIERA, Treviso (IT); Simone ROSETTA, Treviso (IT); Eros SARTORI, Treviso (IT)

(73) Assignee: DE' LONGHI APPLIANCES S.r.l., Treviso (IT)

(21) Appl. No.: 18/861,039

(22) PCT Filed: Apr. 28, 2023
(86) PCT No.: PCT/EP2023/061333

§ 371 Date: Oct. 28, 2024

(30) Foreign Application Priority Data
May 4, 2022 (IT) 102022000009155

(51) Int. Cl. A47J 31/44; A47J 31/46

(52) U.S. Cl. CPC A47J 31/4485; A47J 31/461; A47J 31/469

(57) ABSTRACT

A Device for frothing milk comprising: a milk container; a manifold for the suction of air and milk by Venturi effect from a first line for the withdrawal of air from the external atmospheric environment and respectively from a second line for the withdrawal of milk from said container; a line for the inlet of steam into the manifold for triggering the Venturi effect; means for adjusting the minimum air passage port along said first air withdrawal line; and means for adjusting the minimum milk passage port along said second milk withdrawal line.

### CROSS-REFERENCE TO RELATED APPLICATIONS

This is a U.S. National Phase Application under 35 U.S.C. 371 of International Patent Application No. PCT/EP2023/061333, filed Apr. 28, 2023, which claims benefit of priority to Italian Patent Application No. 102022000009155, filed May 4, 2022. The entire contents of these applications are hereby incorporated by reference.

### FIELD OF THE INVENTION

The present invention refers to a device for frothing milk and to a coffee machine including such device.

Devices for frothing milk that can be associated with a coffee machine have long been known. Some types of known devices comprise a milk container provided with a lid incorporating a Venturi effect mixing chamber where air and milk collected from the container are mixed by Venturi effect triggered by a steam flow.

The way of air access to the mixing chamber can be provided with a progressively opening valve by operating on which the degree of frothing the milk can be modified.

One of the limitations of these types of known devices is the limited capacity to diversify the range of frothed milk that can be produced.

In particular, with these types of known devices it is not possible to produce cold-frothed milk as the steam flow that serves to trigger the Venturi effect and the withdrawal of milk heats the milk sucked into the mixing chamber.

Such known devices for frothing milk may complain of other drawbacks including the complexity of accessing internal components for inspection and cleaning.

This problem is quite relevant if one thinks that any milk residues that solidify inside the device can create blockages of the milk flow passage ports and thus alter the efficiency of the device.

Last but not least, milk residues that solidify inside the device can also negatively affect the organoleptic characteristics of the product and generate unpleasant malodorous exhalations.

For this reason, such devices can provide for the injection of liquid detergents for washing the internal parts which obviously must be carefully rinsed.

EP1115317 B1 shows a device for frothing milk including a tap for adjusting the flow of milk sucked by Venturi effect.

This device complains of a poor flexibility of use for the dispensing of beverages in a wide range of temperatures and frothing degrees.

### SUMMARY

The technical task of the present invention is, therefore, to realize a device for frothing milk and a coffee machine which obviate the technical drawbacks described above of the prior art.

Within the scope of this technical task an object of the invention is to realize a device for frothing milk and a coffee machine that includes such device that allow to directly produce in the cup a wide range of products based on hot or cold-frothed milk with various frothing degrees.

Another object of the invention is to make fully automatic the functions for the production of a wide range of milk-based products selectable by a user.

Another object of the invention is to realize a device for frothing milk easily inspectable and cleanable.

Another object of the invention is to make fully automatic also a function of accurate cleaning of the device selectable by a user.

Another object of the invention is to provide an extremely safe device for frothing milk.

The technical task, as well as these and other objects according to the present invention are achieved by realizing a device for frothing milk characterized in that it comprises: a milk container; a manifold for the suction of air and milk by Venturi effect from a first line for the withdrawal of air from the external atmospheric environment and respectively from a second line for the withdrawal of milk from said container comprising a first milk withdrawal conduit and a second milk withdrawal conduit; a line for the inlet of steam into the manifold for triggering the Venturi effect; means for adjusting the minimum air passage port along said first air withdrawal line; and means for adjusting the minimum milk passage port along said second milk withdrawal line comprising a valve means for shutting off said second milk withdrawal conduit.

In an embodiment of the invention said means for adjusting the minimum air passage port along said first air withdrawal line is switchable at least between a first switching state to which a first minimum air passage port corresponds and a second switching state to which a second minimum air passage port greater than the first minimum air passage port corresponds, and said means for adjusting the minimum milk passage port along said second milk withdrawal line is switchable at least between a first switching state to which a first minimum milk passage port corresponds and a second switching state to which a second minimum milk passage port greater than the first minimum milk passage port corresponds.

In an embodiment of the invention said first air withdrawal line comprises a first air withdrawal conduit and a second air withdrawal conduit, and said means for adjusting the minimum air passage port comprises a first valve means for shutting off said first air withdrawal conduit and a second valve means for shutting off said second air withdrawal conduit.

In an embodiment of the invention said first valve means for shutting off said first air withdrawal conduit comprises a first solenoid valve and said second valve means for shutting off said second air withdrawal conduit comprises a second solenoid valve.

In an embodiment of the invention said first air withdrawal conduit and said second air withdrawal conduit are communicating.

In an embodiment of the invention said valve means for shutting off said second milk withdrawal conduit comprises a manual valve.

In an embodiment of the invention said manual valve comprises a shutter stem rotatable on itself in a valve body intersecting said second milk withdrawal conduit, said stem having a passageway that is alignable with said second conduit for opening said second milk withdrawal conduit.

In an embodiment of the invention said first milk withdrawal conduit and said second milk withdrawal conduit are communicating.

In an embodiment of the invention said manifold is incorporated for closing said milk container.

In an embodiment of the invention the device for frothing milk comprises an electronic controller presenting programs for dispensing a beverage which provide for the selection of a state of the means for adjusting the minimum air and milk passage port.

In an embodiment of the invention said electronic controller has a cleaning program that provides for the selection of a state of the means for adjusting a minimum air passage port that is so wide as to prevent the back suction of milk towards said manifold.

The invention also discloses a coffee machine including such a milk frothing device.

In an embodiment of the invention said device has removable connection means between a wall of said lid and a wall of said coffee machine.

### BRIEF DESCRIPTION OF THE DRAWINGS

Further features and advantages of the invention will become more apparent from the description of a non-exclusive embodiment thereof, of the device for frothing milk and of the machine that includes said device according to the invention, illustrated by way of non-limiting example in the drawings, in which:

FIG. 1 shows a front view of a coffee machine including the device for frothing milk;

FIG. 2 shows a front view of the coffee machine of FIG. 1 from which the milk container was removed;

FIG. 3a shows a side elevation view in vertical section of the coffee machine of FIG. 1 where the components of the device for frothing the milk are highlighted, where the milk container provided with lid is removed from the front wall of the coffee machine;

FIG. 3b shows a side elevation view in vertical section of the coffee machine of FIG. 1 where the components of the device for frothing the milk are highlighted, where the milk container provided with lid is connected to the front wall of the coffee machine;

FIGS. 4 and 5 show axonometric views of the milk container provided with lid of the device for frothing milk;

FIGS. 6a, 6b and 6c show in exploded view the container provided with lid;

FIGS. 7a and 7b show a vertical section of the milk container provided with a lid of the device for frothing milk of FIG. 6b, wherein the means for adjusting the minimum milk passage port is shown in the first state and respectively in the second state; and

FIG. 8 shows a vertical section of the milk container provided with a lid of the device for frothing milk rotated by 90° with respect to FIGS. 7a and 7b.

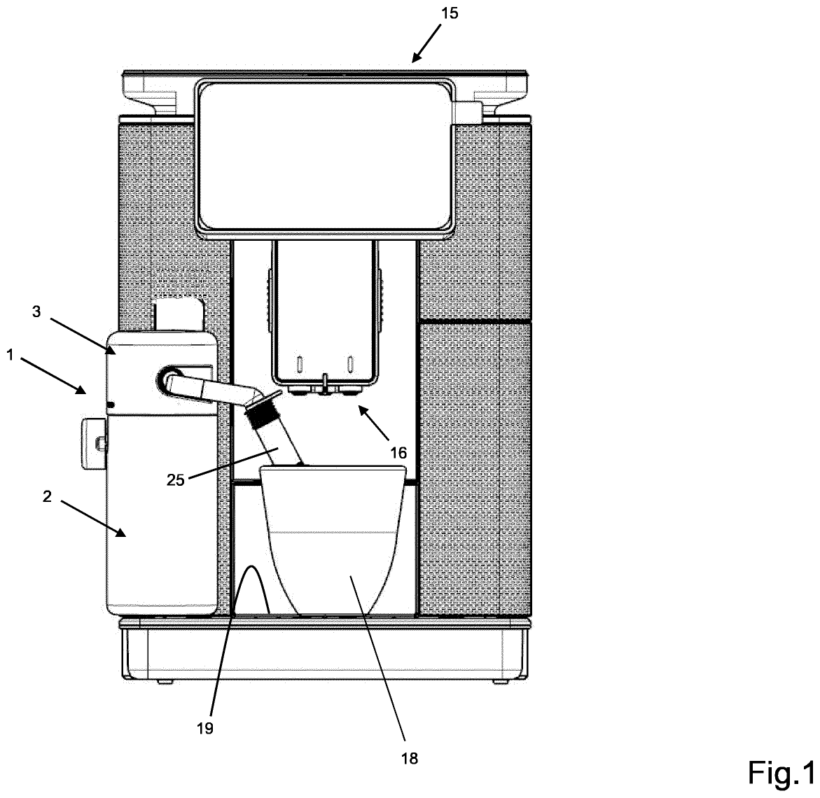

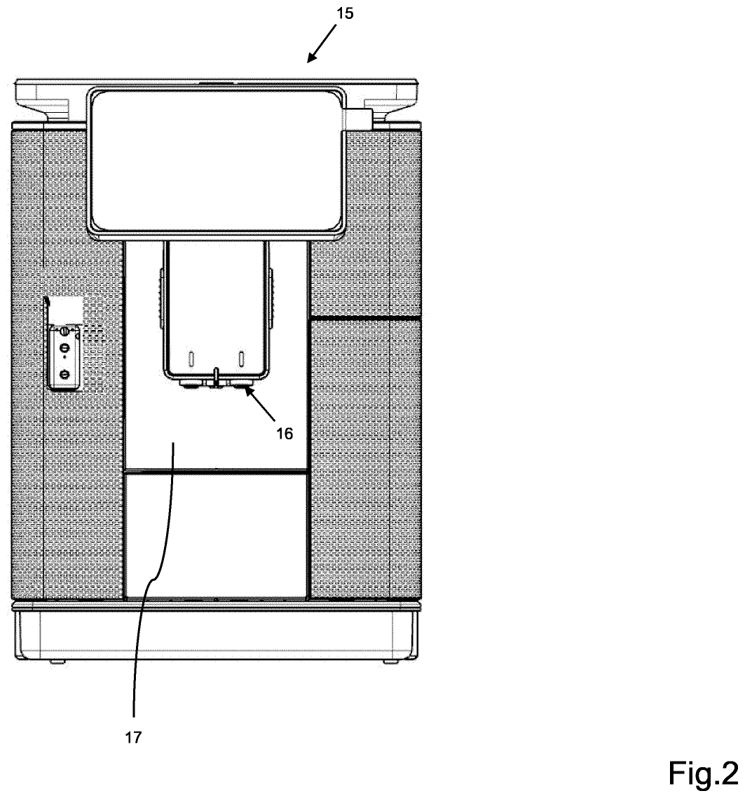

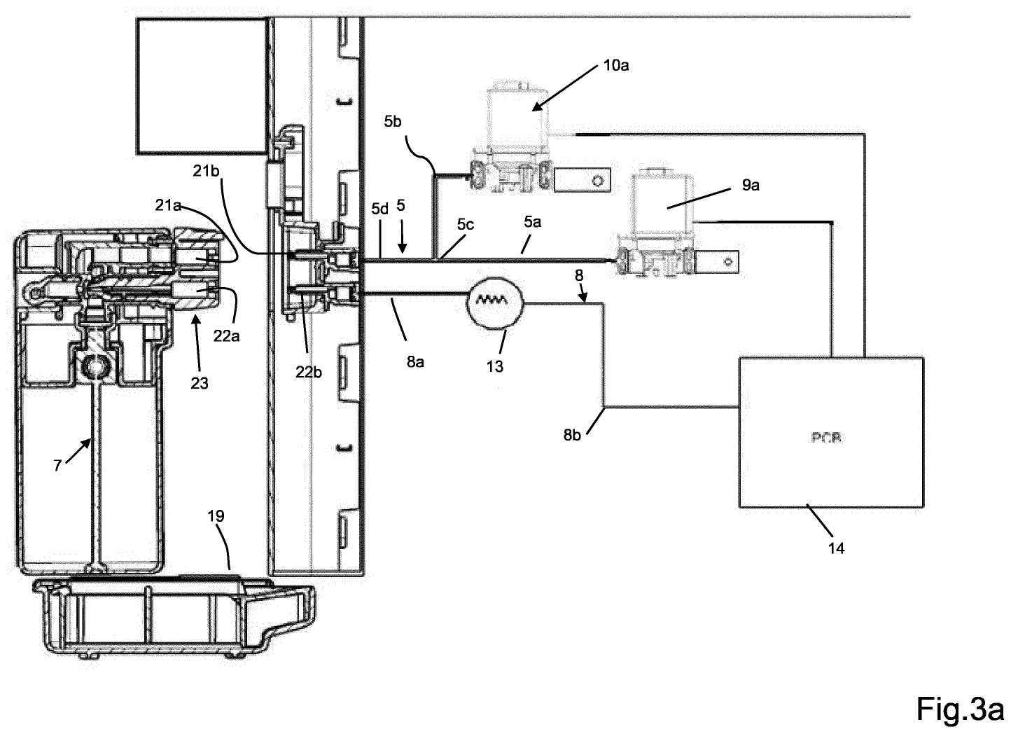

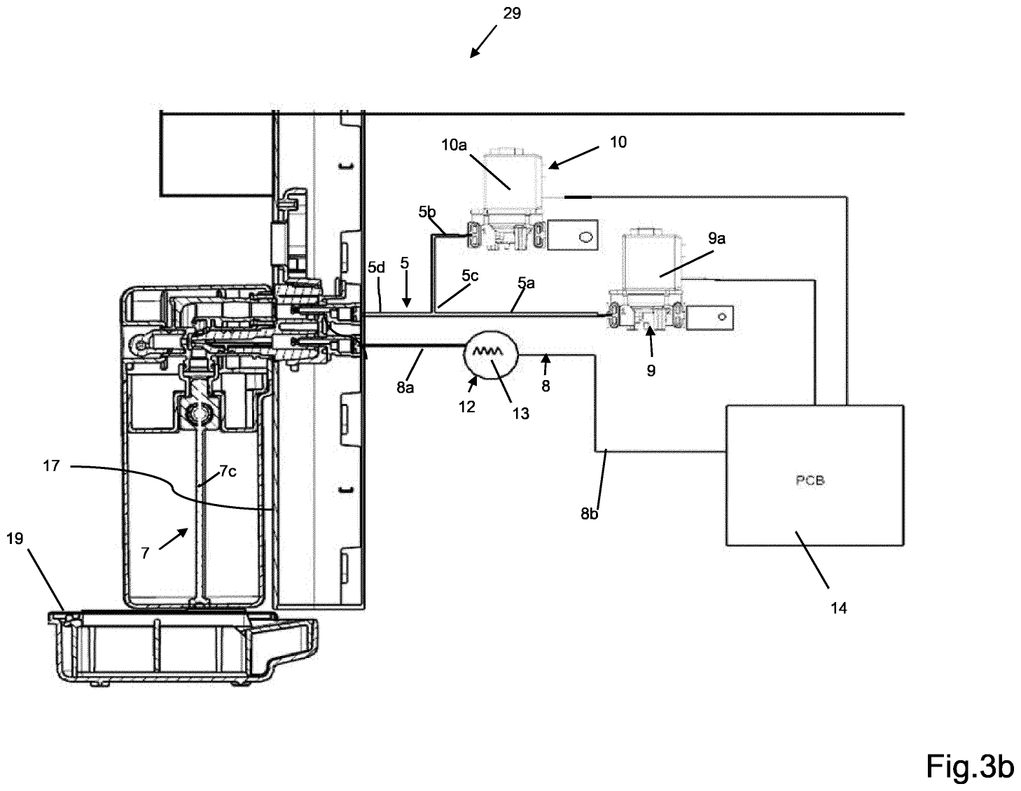

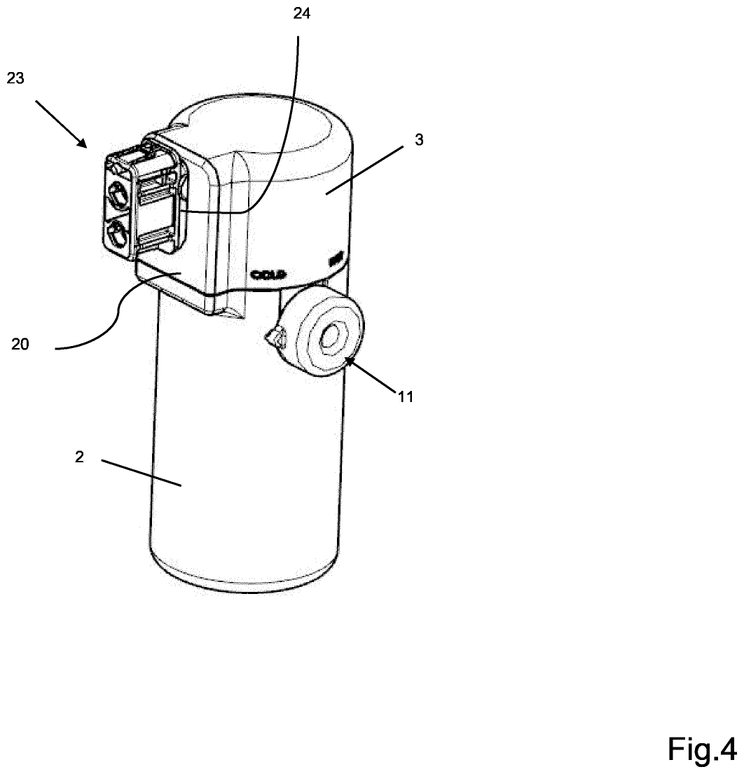

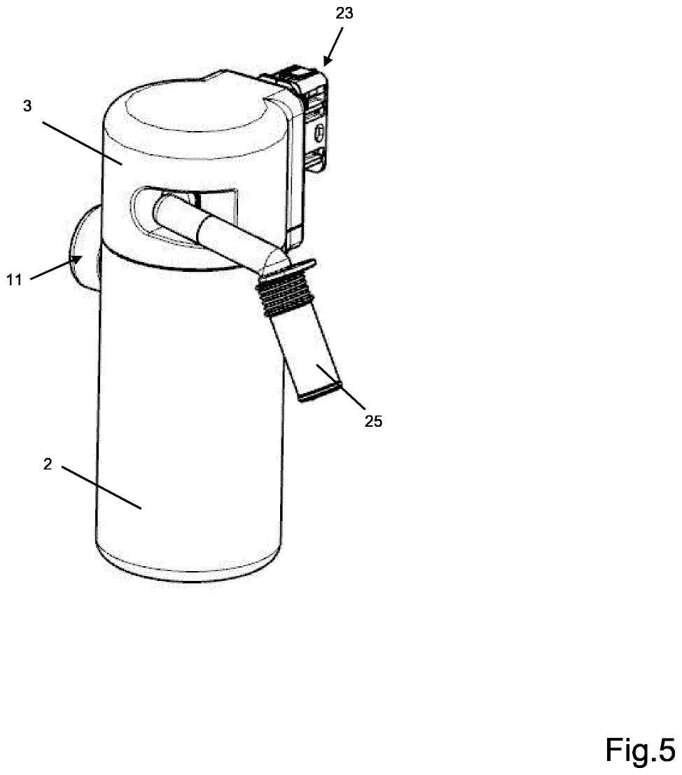

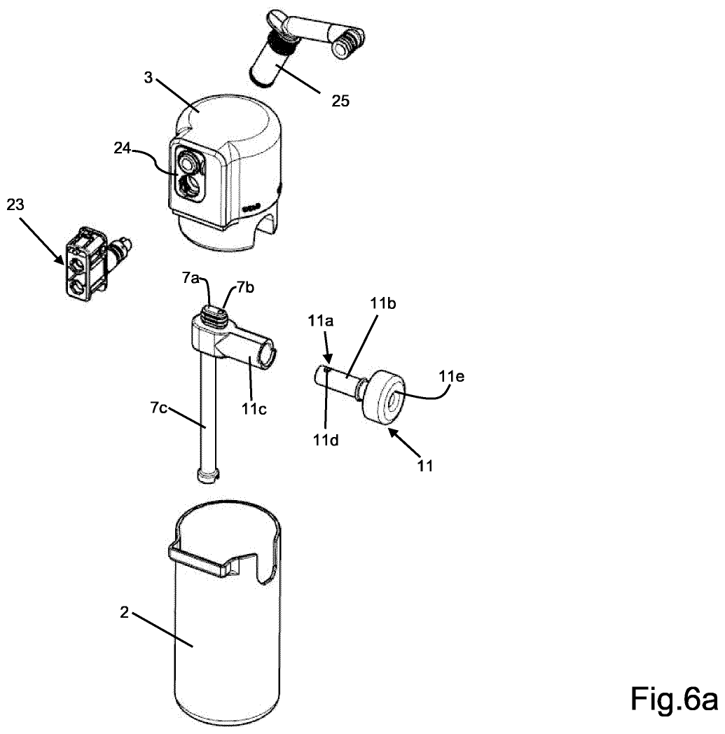

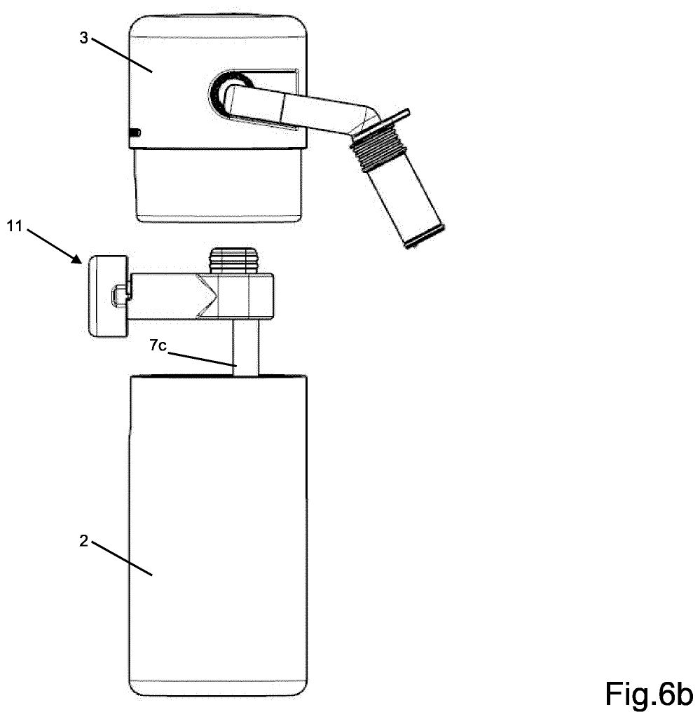

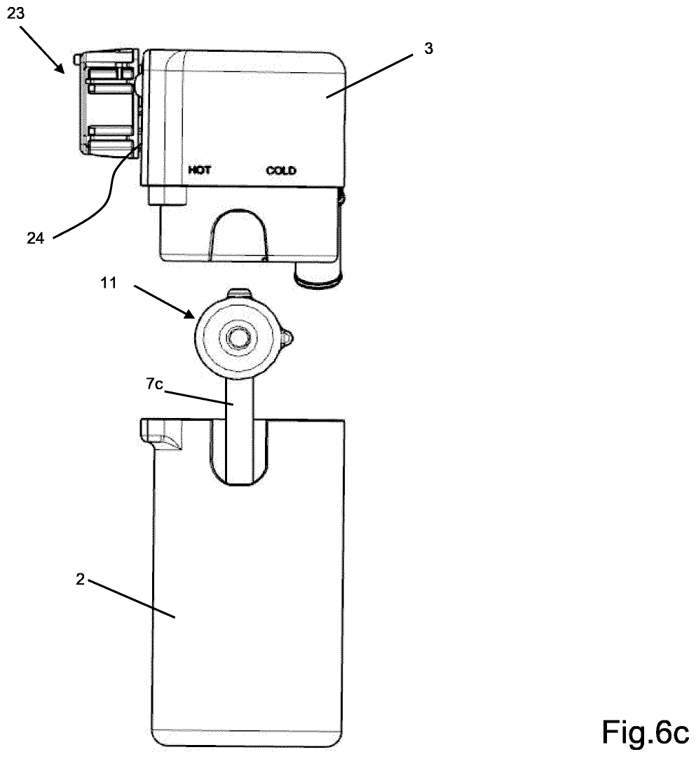

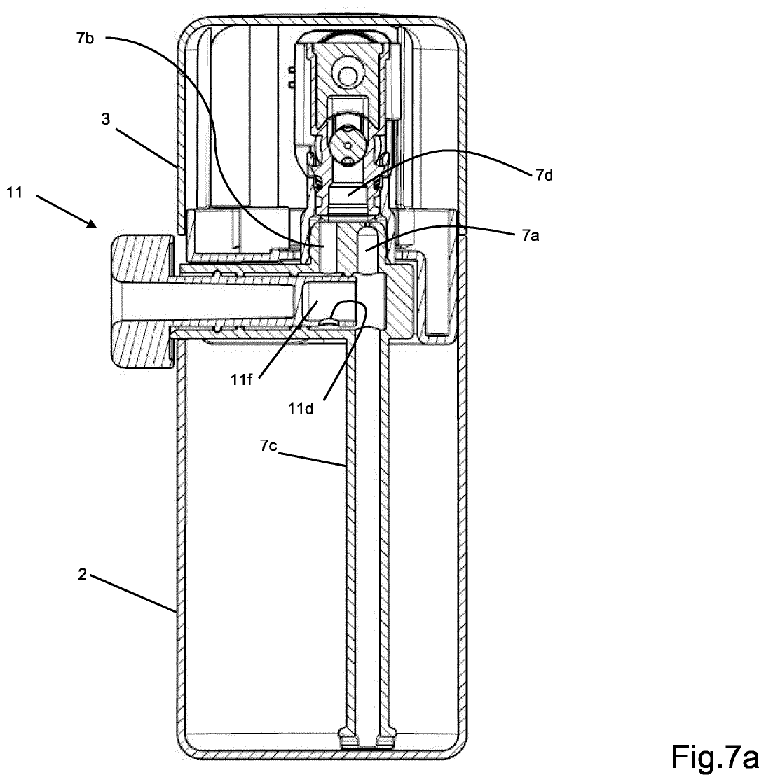

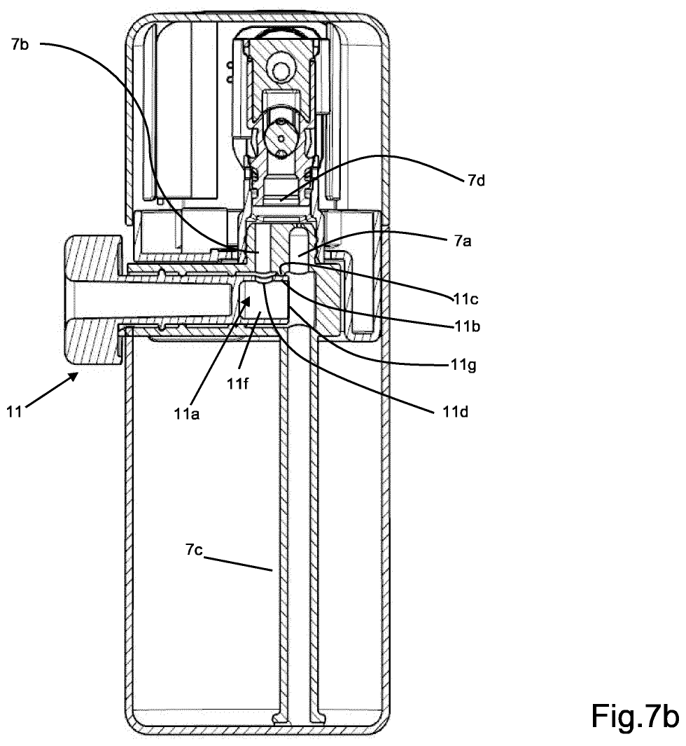

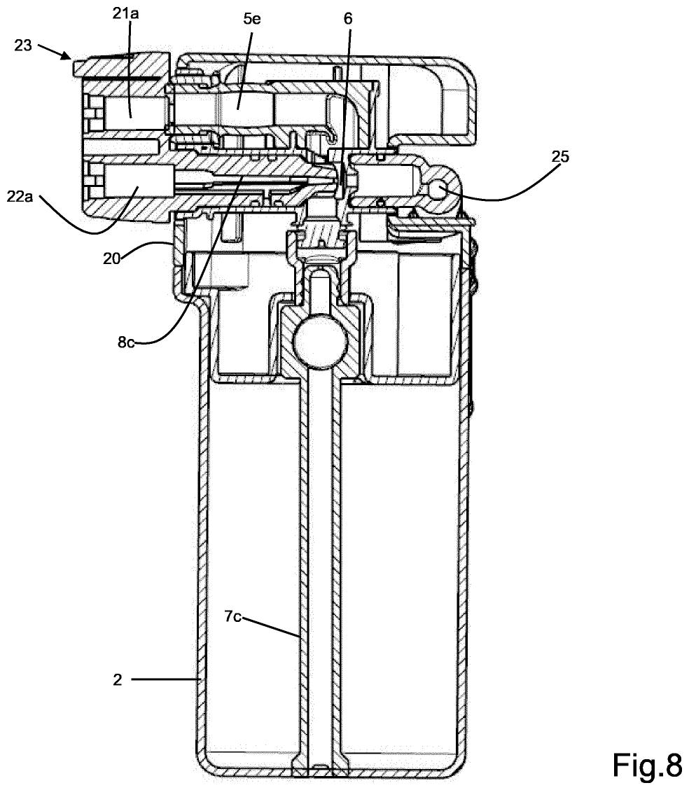

### DETAILED DESCRIPTION

With reference to the aforementioned figures, a device for frothing milk indicated as a whole with reference numeral 1 is shown.

The device 1 comprises a milk container 2 provided with a closing lid 3, and an external milk dispenser 25.

The closing lid 3 is may be configured for a closure of the milk container 2.

The lid 3 can be removed from the container 2 to refill the container 2 with fresh milk once it is empty.

The lid 2 has a hollow structure to house inside it, as we will see, some components of the device 1.

The device 1 comprises manifold 6 for the suction of air and milk by Venturi effect, may be housed in the lid 2 and connected at the outlet to the external milk dispenser 25.

The device 1 comprises a first line 5 for the withdrawal of air from the external atmospheric environment and a second line 7 for the withdrawal of milk from the container 2.

The air withdrawal line 5 and the milk withdrawal line 7 communicate with the manifold 6 which can then withdraw air and milk from them respectively by Venturi effect.

The device 1 provides a line 8 for the inlet of steam into the manifold 6 for triggering the Venturi effect.

The device 1 also provides means for adjusting the minimum air passage port along the first air withdrawal line 5.

The means for adjusting the minimum air passage port along the first air withdrawal line 5 is switchable at least between a first switching state to which a first minimum air passage port along the first air withdrawal line 5 corresponds and a second switching state to which a second minimum air passage port along the first air withdrawal line 5 corresponds, where the second minimum air passage port is greater than the first minimum air passage port.

The device 1 also provides means for adjusting the minimum milk passage port along the second milk withdrawal line 7.

The means for adjusting the minimum milk passage port along the second milk withdrawal line 7 is switchable at least between a first switching state to which a first minimum milk passage port corresponds and a second switching state to which a second minimum milk passage port greater than the first minimum milk passage port corresponds.

The first air withdrawal line 5 comprises a first air withdrawal conduit 5a and a second air withdrawal conduit 5b.

The means for adjusting the minimum air passage port comprises first valve means 9 for shutting off the first air withdrawal conduit 5a and second valve means 10 for shutting off the second air withdrawal conduit 5b.

The first valve means 9 for shutting off the first air withdrawal conduit 5a comprises a first solenoid valve 9a.

The second valve means 10 for shutting off the second air withdrawal conduit 5b comprise a second solenoid valve 10a.

The first minimum air passage port along the first air withdrawal line 5 may correspond to the opening of only the first air withdrawal conduit 5a by the first solenoid valve 9a.

In practice the first minimum air passage port along the first air withdrawal line 5 in this case corresponds to the minimum air passage port of the first air withdrawal conduit 5a.

The minimum air passage port of the first air withdrawal conduit 5a may be the one on which the first solenoid valve 9a intervenes through closing and opening.

The second minimum air passage port along the first air withdrawal line 5 may correspond to the opening of the only second air withdrawal conduit 5b by the second solenoid valve 10a.

In practice, the second minimum air passage port along the first air withdrawal line 5 corresponds in this case to the minimum air passage port of the second air withdrawal conduit 5b.

The minimum air passage port of the second air withdrawal conduit 5b is therefore greater than the minimum air passage port of the first air withdrawal conduit 5a.

The minimum air passage port of the second air withdrawal conduit 5b may be the one on which the second solenoid valve 10a intervenes through closing and opening.

The minimum air passage port of the first air withdrawal conduit 5a has a diameter comprised between 0.05 mm and 0.20 mm, while the minimum air passage port of the second air withdrawal conduit 5b has a diameter comprised between 0.20 mm and 1.00 mm.

The air passage ports are calibrated to obtain, thanks to the trigger of the Venturi effect, a sucked air flow comprised between 1.3 cc/s and 4 cc/s when the first air withdrawal conduit 5a is open, and a sucked air flow comprised between 5 cc/s and 9 cc/s when the second air withdrawal conduit 5b is open.

The first air withdrawal conduit 5a and the second air withdrawal conduit 5b are communicating at a branch node 5c of the first air withdrawal line 5.

Downstream (in the direction of the air flow) of the branch node 5c the single conduit 5d of the first air withdrawal line 5 feeding the manifold 6 has, as mentioned above, a minimum air passage port not lower than the minimum air passage port of the second air conduit 5b.

The second milk withdrawal line 7 comprises a first milk withdrawal conduit 7a and a second milk withdrawal conduit 7b.

The means for adjusting the minimum milk passage port comprises valve means 11 for shutting off the second milk withdrawal conduit 7b.

The valve means 11 for shutting off the second milk withdrawal conduit 7b comprises a manual valve 11a.

The manual valve 11a comprises a knob 11e and a shutter stem 11b rotatable on itself in a valve body 11c intersecting the second milk withdrawal conduit 7b.

The stem 11b internally has a passageway 11f, 11d, 11g align with the second milk withdrawal conduit 7b to open the milk passageway through the second milk withdrawal conduit 7b.

The passageway internal to the stem 11b may include an inner axial chamber 11f of the stem 11b having an axial inlet path 11g and a radial outlet path 11d.

The axial inlet path 11g is always open, while the radial outlet path 11d can be opened or closed depending on the angular position of the stem 11b.

The diameter of the outlet path 11d may be comprised between 3 mm and 8 mm, while the inlet path 11g and the axial chamber 11f have a larger diameter.

The diameter of the minimum passage port of the first milk withdrawal conduit 7a is comprised between 0.5 mm and 2 mm, while the diameter of the minimum passage port of the second milk withdrawal conduit 7b is comprised between 3 mm and 10 mm.

The milk passage ports are calibrated to obtain, thanks to the trigger of the Venturi effect, a sucked flow of milk comprised between 3 gr/s and 6 gr/s when only the first milk withdrawal conduit 7a is open, and a sucked flow of milk comprised between 10 gr/s and 15 gr/s when also the second milk withdrawal conduit 7b is open.

The stem 11b can be made of rigid material such as plastic or metal, while the valve body 11c can be made of rubber to ensure a mutual fluid-tight shape and force connection.

The first milk withdrawal conduit 7a and the second milk withdrawal conduit 7b are communicating.

The first minimum milk passage port along the second milk withdrawal line 7 corresponds to the opening of only the first milk withdrawal conduit 7a.

In practice, the first minimum milk passage port along the second milk withdrawal line 7 corresponds in this case to the minimum milk passage port of the first milk conduit 7a.

The second minimum milk passage port along the second milk withdrawal line 7 corresponds to the opening of also the second milk withdrawal conduit 7b by the manual valve 11.

In practice, the second minimum milk passage port along the second milk withdrawal line 7 corresponds in this case to the sum of the minimum milk passage ports of the first and second milk conduit 7a, 7b.

The minimum milk passage port of the second milk withdrawal conduit 7b is however greater than the minimum milk passage port of the first milk withdrawal conduit 7a.

The first milk withdrawal conduit 7a and the second milk withdrawal conduit 7b are may be communicating at a branch node of the second milk withdrawal line 7.

Upstream (in the direction of the milk flow) of the branch node the single conduit 7c of the first milk withdrawal line 7 extending towards the bottom of the milk container 2 has a minimum milk passage port not lower than the sum of the minimum milk passage ports of the first and second milk withdrawal conduit 7a, 7b.

In this case the first and second milk withdrawal conduit 7a, 7b are joined before accessing the manifold 6.

Downstream (in the direction of the milk flow) of the junction, the single conduit 7d of the first milk withdrawal line 7 which is introduced into the manifold 6 has a minimum milk passage port not lower than the sum of the minimum milk passage ports of the first and second milk withdrawal conduit 7a, 7b.

The steam inlet line 8 in the manifold 6 for triggering the Venturi effect comprises a steam source 12, specifically a boiler 13.

The device 1 finally comprises an electronic controller 14 to which the first solenoid valve 9a, the second solenoid valve 10a and the steam boiler 13 are connected.

The electronic controller 14 is specifically in the form of a PCB board. The device 1 can be integrated into a coffee machine 15.

In this case the electronic controller 14 may be the same as normally provided in the coffee machine 15.

The coffee machine 15 usually has a hydraulic circuit (not shown) which provides in cascade a water source, a water feeding pump, a boiler and an infuser.

The hydraulic circuit of the coffee machine 15 also comprises a steam production line, which may employ the above boiler 13 or a dedicated boiler for the purpose.

The water source can be a tank integrated into the coffee machine or a connection to the water mains.

The infuser is connected to an external coffee dispenser 16 supported by a front wall 17 of the coffee machine 15.

The external coffee dispenser 16 can dispense the beverage directly into a cup 18 below positioned on a front plane 19 for resting cups of the coffee machine 15.

The device 1 as mentioned may share some resources with the coffee machine 15, including the electronic controller 14.

For example, as mentioned, the boiler 13 can also be the one normally provided in the hydraulic circuit of the coffee machine for the production of steam.

The device 1 has removable connection means between a wall 20 of the lid 3 and a wall of the coffee machine 15, specifically the front wall 17 of the coffee machine 15.

The removable connection means includes first fittings 21a, 21b for the connection between a section 5e of the air withdrawal line 5 integrated into the lid 3 and a section 5a, 5b, 5c, 5d, 9a, 10a integrated into the coffee machine 15, and second fittings 22a, 22b for the connection between a section 8c of the steam inlet line 8 integrated into the lid 3 and a section 8a, 8b, 13 integrated into the coffee machine 15.

Inside the coffee machine 15 the section of the air withdrawal line 5 includes the two conduits 5a, 5b and the relative solenoid valves 9a, 10a and the single conduit 5d downstream of the branch 5c.

Still inside the coffee machine 15 the section of the steam inlet line 8 includes the boiler 13, a delivery conduit 8a of the boiler 13 and a feeding conduit 8b of the boiler 13.

The first fitting 21a and the second fitting 22a may be made of a block 23 removably engaged in a housing 24 of the wall 20 of the lid 3.

In practice, between the two walls 17, 20, which are conveniently vertical and flat, there is an interface area where the connections between the lid 3 and the coffee machine 15 necessary for the operation of the device 1 are located.

The fittings 21a, 21b and respectively 22a, 22b are engageable by horizontal coupling. In the position of coupling of the fittings 21a, 21b and respectively 22a, 22b the container 2 rests on the plane 19.

The plane 19 can then be used as a guide for the coupling of the fittings 21a, 21b and respectively 22a, 22b.

The operation of the device 1 according to the invention is evident from what is described and illustrated and, in particular, is substantially the following.

The user can perform a manual selection of a beverage through a special user interface provided by the device 1, and integrated into the coffee machine 15, particularly in the dashboard normally provided by the coffee machine 15.

The selection of the beverage on the user interface may be accompanied by switching of the manual valve 11, if necessary.

In the case of selection via the user interface of the dispensing of a frothed cold milk, the user must ensure that the manual valve is in the opening state, otherwise he must bring it into the opening state; the electronic controller 14 executes a dispensing program that provides for the solenoid valve 9a deactivated which corresponds to the closure of the first air withdrawal conduit 5a, the solenoid valve 10a activated which corresponds to the opening of the second air withdrawal conduit 5b, the manual valve 11 in the opening position also of the second milk withdrawal conduit 7b, and the steam source 12 activated.

The steam flow triggers a Venturi effect through which milk and air are sucked into the manifold 6.

Given that both the milk withdrawal conduits 7a and 7b are open, the steam flow recalls a high flow of milk by Venturi effect, to which it provides a supply of thermal energy that does not cause a significant increase in the temperature of the milk dispensed in the cup.

The same steam flow recalls by Venturi effect, an air flow useful for frothing the milk.

In the case of selection via the user interface of the dispensing of a cold milk without foam, the user must ensure that the manual valve is in the opening state, otherwise he must bring it into the opening state; the electronic controller 14 executes a dispensing program that provides for the solenoid valve 9a deactivated which corresponds to the closure of the first air withdrawal conduit 5a, the solenoid valve 10a deactivated which corresponds to the closure of the second air withdrawal conduit 5b, the manual valve 11 in the opening position also of the second milk withdrawal conduit 7b, and the steam source 12 activated.

Unlike the previous case, the milk is not frothed because of the absence of airflow.

In the case of selection via the user interface of the dispensing of a frothed warm milk, the user must ensure that the manual valve is in the closing state, otherwise he must bring it into the closing state; the electronic controller 14 executes a dispensing program that provides for the solenoid valve 9a activated which corresponds to the opening of the first air withdrawal conduit 5a, the solenoid valve 10a deactivated which corresponds to the closure of the second air withdrawal conduit 5b, the manual valve 11 in the closing position of the second milk withdrawal conduit 7b, and the steam source 12 activated.

The steam flow triggers a Venturi effect through which milk and air are sucked into the manifold 6.

Given that only the first milk withdrawal conduit 7a is open, the steam flow recalls by Venturi effect a modest milk flow to which it provides a supply of thermal energy that causes a significant increase in temperature of the milk dispensed in the cup.

The same steam flow recalls by Venturi effect, an air flow useful for frothing the milk.

In the case of selection via the user interface of the dispensing of a warm milk without foam, the user must ensure that the manual valve is in the closing state, otherwise he must bring it into the closing state; the electronic controller 14 executes a dispensing program that provides for the solenoid valve 9a deactivated which corresponds to the closure of the first air withdrawal conduit 5a, the solenoid valve 10a deactivated which corresponds to the closure of the second air withdrawal conduit 5b, the manual valve 11 in the closure position of the second milk withdrawal conduit 7b, and the steam source 12 activated.

The steam flow triggers a Venturi effect through which milk is sucked into the manifold 6.

Given that only the first milk withdrawal conduit 7a is open, the steam flow recalls by Venturi effect a modest milk flow to which it provides a supply of thermal energy that causes a significant increase in temperature of the milk dispensed in the cup.

The same steam flow cannot recall by Venturi effect an air flow useful for frothing the milk because of the complete closure of the air withdrawal line 5.

The user can also select a cleaning function.

In case the user selects the cleaning function, the electronic controller 14 executes a cleaning program that provides for the solenoid valve 9a activated which corresponds to the opening of the first air withdrawal conduit 5a, the solenoid valve 10a activated which corresponds to the opening of the second air withdrawal conduit 5b, the manual valve 11 in any position, and the steam source 12, intermittently, activated.

The steam flow triggers a Venturi effect whereby only air is sucked into the manifold 6 due to the high passage port open along the air withdrawal line 5 which prevents the suction of milk from the container 2.

The user interface may include a display which, at each selection of a beverage by the user, displays a warning for the user to make the correct manual selection of the switching state of the manual valve 11.

Alternatively, the device 1 can provide a position sensor, for example of magnetic type, which identifies the angular position of the shutter stem and therefore the switching state of the manual valve 11 and, if the current switching state is not congruent with the selection of the beverage made by the user, enables the automatic display on the user interface display of a warning for the user to change the switching state of the manual valve 11.

The device 1 has a very high flexibility of use.

Since the milk dispenser 25 can be oriented to dispense directly into the same cup 18 where the coffee dispenser 16 dispenses, the user can obtain a beverage with a simple manual selection operation on the user interface and on the manual valve 11.

Selectable and producible milk-based beverages are of various kinds.

Beverages at a temperature no more than 20° C. higher than the temperature of the milk present in the milk container can typically be obtained.

For example, cold beverages can be obtained at a temperature not higher than 25° C. when the temperature of the milk present in the milk container is comprised between 3° C. and 10° C., using dispensing programs that provide for the selection of the state of the manual valve 11 which corresponds to the opening of the second milk withdrawal conduit 7b.

Hot beverages can also typically be obtained at a temperature up to 65° C. higher than the temperature of the milk present in the milk container.

For example, hot beverages can typically be obtained with temperatures between 50° C. and 75° C. when the temperature of the milk present in the milk container is comprised between 3° C. and 10° C., employing dispensing programs that provide for the selection of the state of the manual valve 11 which corresponds to the closure of the second milk withdrawal conduit 7b.

Beverages with varying proportions between milk and coffee can be obtained simply by providing dispensing programs with different duration of activation of the boiler 13.

Beverages with or without foam can be obtained simply by providing dispensing programs with opening of one or the other solenoid valve 9a, 10a.

Finally, beverages of various flavors can be obtained simply by providing dispensing programs with different additives or flavorings based on chocolate, vanilla, strawberry or more.

Additives or flavorings, in powder or liquid form, may be added to the milk in container 2.

The conceived device for frothing milk is susceptible to numerous modifications and variations, all falling within the scope of the inventive concept; moreover, all the details can be replaced by technically equivalent elements.

In practice, the materials used, as well as the dimensions, can be any depending on the needs and the state of the art.

1. A device for frothing milk comprising: a milk container; a manifold for the suction of air and milk by Venturi effect from a first line for the withdrawal of air from the external atmospheric environment and respectively from a second line for the withdrawal of milk from said container comprising a first milk withdrawal conduit and a second milk withdrawal conduit that in communication; a line for an inlet of steam into the manifold for triggering the Venturi effect; a means for adjusting a minimum air passage port along said first air withdrawal line; and a means for adjusting a minimum milk passage port along said second milk withdrawal line comprising a valve for shutting off said second milk withdrawal conduit.

2. The device for frothing milk according to claim 1, said means for adjusting the minimum air passage port along said first air withdrawal line is switchable at least between a first switching state to which a first minimum air passage port corresponds and a second switching state to which a second minimum air passage port greater than the first minimum air passage port corresponds, and wherein said means for adjusting the minimum milk passage port along said second milk withdrawal line is switchable at least between a first switching state to which a first minimum milk passage port corresponds and a second switching state to which a second minimum milk passage port greater than the first minimum milk passage port corresponds.

3. The device for frothing milk according to claim 1, wherein said first air withdrawal line comprises a first air withdrawal conduit and a second air withdrawal conduit, and said means for adjusting the minimum air passage port comprises a first valve for shutting off said first air withdrawal conduit and a second valve means for shutting off said second air withdrawal conduit.

4. The device for frothing milk according to claim 3, wherein said first valve for shutting off said first air withdrawal conduit comprises a first solenoid valve and said second valve for shutting off said second air withdrawal conduit comprises a second solenoid valve.

5. The device for frothing milk according to claim 3, wherein said first air withdrawal conduit and said second air withdrawal conduit in communication.

6. The device for frothing milk according to claim 1, wherein said valve for shutting off said second milk withdrawal conduit comprises a manual valve.

7. The device for frothing milk according to claim 6, wherein said manual valve comprises a shutter stem rotatable on itself in a valve body intersecting said second milk withdrawal conduit, said stem having a passageway that is alignable with said second milk withdrawal conduit for opening said second milk withdrawal conduit.

8. The device for frothing milk according to claim 7, wherein said first milk withdrawal conduit and said second milk withdrawal conduit in communication.

9. The device for frothing milk according to claim 1, wherein said manifold is incorporated into a lid for closing said milk container.

10. The device for frothing milk according to claim 2 further comprising an electronic controller presenting programs for dispensing a beverage which provide for a selection of a state for adjusting the minimum air and milk passage port.

11. The device for frothing milk according to claim 10, wherein said electronic controller has a cleaning program that provides for the selection of a state for adjusting the minimum air passage port in which the minimum air passage port is large enough to prevent back suction of milk towards said manifold.

12. A coffee machine including the device for frothing milk according to claim 1.

13. The coffee machine according to claim 12, wherein said device has a removable connection between a wall of said lid and a wall of said coffee machine.

14. The coffee machine according to claim 13, wherein said removable connection includes fittings for the connection between sections of the air withdrawal line integrated into the lid and respectively into the coffee machine, and between sections of the steam inlet line integrated into the lid and respectively into the coffee machine.
